(19) United States
(12) Patent Application Publication
(10) Pub. No.: US 2004/0260435 A1
(43) Pub. Date: Dec. 23, 2004

(54) Method for carrying out a diagnosis in motor vehicles

(76) Inventors: Mario Jung, Sinzheim (DE); Werner Schmitt, Sinzheim (DE); Klaus Kupper, Buhl (DE); Johannes Moosheimer, Buhl (DE); Michael Schindler, Buhl-Neusatz (DE); Thilo Reichel, Wilnsdorf (DE)

Correspondence Address: DARBY & DARBY P.C., P. O. BOX 5257, NEW YORK, NY, 10150-5257, US

(21) Appl. No.: 10/484,521

(22) PCT Filed: Jul. 12, 2002
(86) PCT No.: PCT/DE02/02557

(30) Foreign Application Priority Data
Jul. 18, 2001 (DE) 101 35 002.3

(51) Int. Cl. G05D 1/00

(52) U.S. Cl. 701/29; 701/1

(57) ABSTRACT

The present invention provides a method for performing a diagnostic operation in motor vehicles, a method for operating a motor vehicle, a electronic control unit, and an electronic testing device, that differs from conventional methods and/or control units and/or testing devices by at least one characterizing feature and that it is novel relative to the known methods and/or devices.

The invention relates to methods for performing a diagnostic operation in motor vehicles, a method for operating a motor vehicle, an electronic testing device, and an electronic control unit.

Methods for performing a diagnostic operation in motor vehicles, methods for operating a motor vehicle, electronic testing devices and electronic control units are already known in the art.

The object of the invention is to provide a differently designed method for performing a diagnostic operation in motor vehicles, a differently designed method for operating a motor vehicle, a differently designed electronic control unit, and a differently designed electronic testing device, in other words a method and/or control unit and/or testing device of said type that differs from the known embodiments in at least one characterizing feature, so that it is considered novel relative to these known embodiments under patent law.

The object is attained with a method for performing a diagnostic operation in motor vehicles that possesses at least one characterizing feature from the characterizing features that are specified in the following description or in the claims, or that are shown in the drawings.

The object is attained with a method for operating a motor vehicle that possesses at least one characterizing feature from the characterizing features that are specified in the following description or in the claims, or that are shown in the drawings.

The object is attained with an electronic control unit that possesses at least one characterizing feature from the characterizing features that are specified in the following description or in the claims, or that are shown in the drawings.

The object is attained with an electronic testing device that possesses at least one characterizing feature from the characterizing features that are specified in the following description or in the claims, or that are shown in the drawings.

The object is especially attained with a method pursuant to claim 1 or pursuant to claim 2 or pursuant to claim 3 or pursuant to claim 4 or pursuant to claim 5.

The object is further especially attained with an electronic control unit pursuant to claim 41.

The object is further especially attained with an electronic testing device pursuant to claim 42.

Preferred embodiments of the invention are the object of the sub-claims.

According to the invention, especially a method for performing a diagnostic operation in motor vehicles is provided, in which the instantaneous voltage supply to an electronic control unit in the motor vehicle is ascertained and compared with a preset voltage limit. The control unit emits signals and receives signals within the framework of the diagnostic operation.

Within the meaning of the present invention, a diagnostic operation in motor vehicles or for motor vehicles is to be understood in particular as the checking of predetermined functionalities of the motor vehicle or the checking of predetermined characteristic values that influence predetermined functionalities. It must be noted, however, that the invention is not to be limited by this definition of the term “diagnostic”.

The ascertainment of instantaneous voltage supply and the comparison of this instantaneous voltage supply with the preset voltage limit are preferably carried out within the framework of the diagnostic operation. According to the invention, it is preferred in this connection that this ascertainment and this comparison are carried out prior to the transmission of a first diagnostic request, or during or following such a diagnostic request.

Within the meaning of the present invention, a diagnostic request is understood to mean specifically that a signal is emitted, indicating that one or more predetermined components or functionalities or characteristic values of the motor vehicle are to undergo a diagnostic operation. It is noted, however, that this shall not serve to limit the invention.

The voltage limit can be a voltage level that is dependent upon or independent of the diagnostic routine and/or diagnostic request to be implemented.

The voltage limit can have the same value or different values in each case, wherein in the case of differing values it is especially provided that the concrete voltage limit is dependent upon predetermined characteristic values or diagnostic routines or diagnostic requests or similar factors.

In the preferred embodiment a fault is indicated if the ascertained instantaneous voltage supply is below the voltage limit.

In the preferred embodiment, the fault is dependent upon the concrete diagnostic request and/or the concrete diagnostic routine. Thus different embodiments of fault indicators can be produced that thus show in which diagnostic request and/or diagnostic routine the voltage supply of the electronic control unit was below the voltage limit.

In one preferred embodiment, despite a diagnostic command or despite a diagnostic request, diagnostic routines are not carried out if it has been determined that the voltage supply of the control unit lies below the preset limit.

In the preferred embodiment the ascertainment of the instantaneous voltage supply is automatically carried out. It is further preferred that the comparison of the instantaneous voltage supply of the control unit with the preset voltage limit is automatically carried out. Most preferably, the indication of a fault, which is registered and/or indicated when the ascertained instantaneous voltage supply is below the voltage limit, is automatically effected.

In the particularly preferred embodiment, the cancellation of a fault of this type is automatically effected, based upon preset characteristic values or events, or similar factors.

Preferably, the ascertainment of the instantaneous voltage supply and/or the comparison of this instantaneous voltage supply of the control unit with the preset voltage limit is implemented or controlled by the control unit. It is further preferred that the indication of the fault is implemented or controlled by the control unit.

It is preferably provided that in order to execute a diagnostic process as specified in the invention, an electronic control unit in a motor vehicle is placed in a signal connection with a testing device.

A testing device of this type is especially an electronic device outside of the vehicle, which can be placed in a wireless or a wired signal connection with the electronic control unit. In the preferred embodiment a testing device of this type is designed as a so-called hand-held tester.

Within the meaning of the present invention, the electronic control unit is preferably designed as an electronic control unit in a clutch assembly, or as an electronic control unit in a transmission assembly, or as a master control unit.

It is most preferably provided that the motor vehicle to undergo diagnostics is equipped with a clutch assembly and a transmission assembly.

In a particularly preferred embodiment, the clutch assembly is designed as an automated clutch. An exemplary automated clutch assembly of this type is proposed by the applicant under the name “electronic clutch management (ECM)”.

The transmission assembly is preferably designed as an automated transmission assembly. It is noted, however, that other transmission assemblies, such as manual transmissions or automatic transmissions, etc., are also preferred.

Preferably, the voltage supply of the control unit is checked via the testing device. It is most preferably provided that, before emitting a diagnostic request, the testing device sends a command to the control unit for a read-out of the operational voltage. If this instantaneous operational voltage is above the preset voltage limit, one or more diagnostic requests are sent out. Preferably, such a diagnostic request is not sent out if it is determined that the voltage supply of the electronic control unit is below the preset limit.

The comparison of the instantaneous voltage supply value with the limit can take place specifically in the control unit or in the testing device.

It is further preferred that the decision regarding whether a diagnostic request is to be sent out and/or executed can be made in the diagnostic unit or in the control unit.

It is further preferred that the testing device independently checks the operational voltage of the electronic control unit, specifically without the interconnection of an electronic control unit. Without hereby limiting the invention, this can be accomplished, for example, by tapping the voltage at the ISO-K plug connector, where ordinarily the same operational voltage is present as at the electronic control unit. Other possibilities are also preferred, however.

Most preferably, it is provided especially with this latter variant that in the testing device the voltage level of this operational voltage is assessed, or the operational voltage of the control unit is compared with a preset limit, after which a decision is made as to whether or not a diagnostic request will be implemented.

The object is further attained especially with a method pursuant to claim 2.

According to the invention, especially a method for performing a diagnostic operation in motor vehicles is provided, in which diagnostic software is loaded into an electronic control unit in the motor vehicle for the purpose of performing the diagnostic operation, wherein said software can control at least one preset diagnostic algorithm or one preset diagnostic routine and/or can effect its implementation. Following the completion of a diagnostic operation, the diagnostic software in the control unit or in a memory unit of the control unit is deleted. This deletion can in particular be effected automatically.

The software can be deleted immediately upon completion of the diagnostic operation, or at a later time. The control software can control a multitude of diagnostic routines and can effect their implementation or individual operations.

Particularly if different software programs for implementing diagnostic procedures are provided, the deletion of the control software in the control unit or from its memory can be delayed until the completion of the diagnostic algorithm or diagnostic routine implemented or controlled by this software. It is further preferred that the software is deleted from the control unit or from its memory unit immediately upon completion of a diagnostic routine or the diagnostic routines that are controlled by this software, or whose implementation is effected by the software.

In the preferred embodiment, the control software is transmitted by a testing device into the electronic control unit.

The deletion of the control software following an executed diagnostic operation can be initiated by the testing device or by the control unit or by the diagnostic software that is stored in the control unit and is to be deleted.

Preferably, a testing device initiates the implementation of the applicable diagnostic algorithm or the applicable diagnostic routine. It is further preferred that the testing device monitors this implementation.

In this connection the term initiates is especially to be understood in that the implementation of the diagnostic algorithm is to be triggered by a command from the testing device, while the algorithm itself or the diagnostic routine is implemented and controlled by the software that is temporarily stored in the control unit.

In the preferred embodiment, predetermined diagnostic results are indicated to the testing device.

It is preferably provided that the diagnostic software serves to prevent the motor vehicle from being operable and operated in normal mode. Further preferred is that the diagnostic software enables normal operation of the motor vehicle only with a corresponding clear warning, which can be implemented, for example, with an acoustic or optical signal or some otherwise perceptible signal.

For example, without serving hereby to limit the invention, the diagnostic software can suppress input and output in a CAN bus system, or can suppress a starter release.

It is further preferred that the diagnostic software permits the implementation of a diagnostic routine or a diagnostic algorithm only when preset operational parameters are present. For example, without serving hereby to limit the invention, it can be provided that a diagnostic routine or a diagnostic algorithm can be implemented only when the vehicle speed is zero and/or the engine speed is zero.

It is further preferred that upon completion of the diagnostic operation at least one preset start-up routine is or must be executed. This request can be effected, for example, by the diagnostic software. This can be the case, for example, without serving hereby to limit the invention, in that the diagnostic software causes normal operation of the motor vehicle to be impossible until a start-up routine has been executed following completion of the diagnostic operation.

A start-up routine is specifically a routine in which preset operational characteristic values for the motor vehicle or for motor vehicle components, which can have different values, are checked. This may be, for example, the position of an actuator or the allocation of an actuator position to a sensing device, which ascertains various actuator positions. This shall not serve to limit the invention, however.

The object is further attained with a method pursuant to claim 3.

According to the invention, especially a method for performing a diagnostic operation in motor vehicles is provided, in which within the framework of a diagnostic routine the functionality of at least one position sensing device allocated to the vehicle is checked.

In the preferred embodiment this position sensing device is a position sensing device that is allocated to the clutch assembly or to a transmission assembly of the motor vehicle.

In the preferred embodiment the position sensing device detects positions and/or changes in position of a movably arranged component.

This movably arranged component is preferably an actuator that is equipped with an electric motor, and/or a component of the actuator, and/or a component that is acted upon by or can be moved by an actuator of this type.

In the particularly preferred embodiment the position sensing device is equipped with at least one incremental sensor. Preferably the position sensing device is equipped with precisely one incremental sensor or is an incremental sensor.

Most preferably the incremental sensor is designed as a Hall sensor or is equipped with a Hall sensor.

The diagnostic routine for the diagnostic operation on the position sensing device can be performed for one or for more position sensing devices. For several position sensing devices the diagnostic operation can be performed in a diagnostic sequence or in separate, especially sequential, diagnostic sequences.

Preferably, the movably arranged component of the motor vehicle, whose position or change in position is ascertained by the position sensing device, is moved within the framework of the diagnostic routine, wherein the change in position ascertained by the position sensing device is monitored and checked for plausibility.

Preferably it is provided that the diagnostic routine for the diagnostic operation on the position sensing device is initiated or triggered by a testing device.

Further, it is especially preferred that the diagnostic routine for the diagnostic operation on the position sensing device is controlled and/or implemented by an electronic control unit in the motor vehicle.

In the preferred embodiment, the movably arranged component, whose positions or changes in position in normal operation are monitored by the position sensing device, moves back and forth between two extreme positions at least one time within the framework of the diagnostic routine. An extreme position of this type is preferably a limit stop.

The two extreme positions or limit stops are preferably stops that limit the mobility of the movably arranged component in the opposite orientations of a direction.

For example, without serving hereby to limit the invention, the extreme positions can be limit stops in a selector track or a gear track.

It is preferably provided that within the framework of the diagnostic routine, the position values indicated by the position sensing device are ascertained or checked, these being indicated by the position sensing device prior to and following a back and forth movement of the movably arranged elements. This back and forth movement is carried out at least one time between the end positions. Preferably, position values that are indicated by the position sensing device in reference to the same end position, prior to and following the back and forth movement, are compared.

In the preferred embodiment it is determined that the position sensing device is functionally impaired when the position sensing device indicates different position values for the same position of the movably arranged component. It is especially provided that this position is one that is essentially clearly identifiable, such as particularly an end position or the same end position of the movably arranged component.

Most preferably, the diagnostic routine for the diagnostic operation on the position sensing device is established to identify directionally dependent functional impairments of the position sensing device. Directionally dependent functional impairments of this kind can be embodied especially such that the position sensing device will indicate a different change in position in a movement from a first position to a second position than in a movement from the second position to the first position, in other words in the opposite direction.

In the preferred embodiment, the movable element, whose position is ascertained or monitored by the position sensing device, is a component of an actuator or a component that is acted upon, specifically is moved, by an actuator.

In the especially preferred embodiment, in the framework of one or more diagnostic routines that are established for a diagnostic operation on a position sensing device, various actuators or the position sensing device allocated to the actuators undergo separate diagnostic operations.

It is preferably provided that during the diagnostics on the position sensing device it is ensured that no reference point adjustments to the position sensing device are carried out.

Preferably, the method for diagnosing the position sensing device is intended for position sensing devices to which actuators are allocated, wherein during the diagnostic operation these actuators are not operated in a “position control” mode, in which preset positions are selected in accordance with routines provided for normal operation.

Preferably, it is further provided that a force and/or speed control with end position recognition for the movably arranged element is provided.

In the preferred embodiment, signals or data can be transmitted between an electronic control unit in the motor vehicle and a testing device outside of the vehicle, via a CAN bus system or via a K-line or in some other manner.

The object is further attained with a method pursuant to claim 4.

According to the invention, especially a method for performing a diagnostic operation in motor vehicles is provided, in which within the framework of the diagnostic operation an electronic testing device is placed in signal connection with an electronic control unit, wherein signals or data are transmitted between the testing device and the control unit via an interface. This interface has a protocol side and an application side. Various modules are allocated to the protocol side and the application side of the interface. The protocol side is preferably a protocol handler, which translates diagnostic commands transmitted from the testing device in the direction of the control unit. The application side especially converts the diagnostic commands or the translated diagnostic commands into diagnostic functions.

In the preferred embodiment, signals or data can be transmitted in both directions between the testing device and the control unit. It is particularly preferably provided that diagnostic results are supplied by the application side and are translated by the protocol side, after which they are transmitted to the testing device.

Preferably, the application side is equipped with a data array. It is further preferred that the protocol side is equipped with a data array.

In the preferred embodiment, the data array on the application side has data that are received by the control unit (received data) or are sent to the control unit.

It is further preferred that the data array on the application side has data that are supplied or sent by the control unit (sent data).

In the preferred embodiment the data array on the protocol side has data that are received by the control unit or are sent to the control unit (received data).

Most preferably, the data array on the protocol side has data that are sent by the control unit (sent data), particularly in the direction of the testing device.

In the preferred embodiment it is provided that the protocol side accesses in writing only the received data.

It is further preferred that the application side accesses in writing only the sent data.

Especially preferably it is provided that a diagnostic request or a transfer protocol is sent via the interface to the electronic control unit within the framework of a diagnostic operation to be performed, wherein the transfer protocol or the corresponding signal is translated in the interface, after which the diagnostic commands are converted to functionalities by the application side using the translated protocol or signal.

It is preferably provided that the diagnostic results are supplied by the application side and then translated by the protocol side, in order to be sent to the electronic testing device.

In the preferred embodiment, the application side and/or the protocol side is equipped with a status byte, which controls the time lapse or the timing of the diagnostic operation.

The object is further attained with a method pursuant to claim 5.

According to the invention, especially a method for operating a motor vehicle is provided, by means of which the motor vehicle can be placed in motion with limited driving functionalities prior to the start-up of an automated clutch assembly. In this, the torque transferred and/or transferable by the clutch assembly is gradually increased when the motor vehicle is to be placed in motion on its own input in accordance with the intentions of the driver.

In this case, the activation is accomplished by means of a diagnostic command.

Preferably it is provided that with this method an actuator, especially an actuator in a transmission assembly, such as an automated manual transmission, or an actuator in a clutch assembly, is provided with parameters during assembly designed to prevent recognition of a specific gear for safety purposes.

In the preferred embodiment, a fault in an electronic control unit in the motor vehicle or in a memory unit of this electronic control unit is registered when the process by which the motor vehicle can be operated with limited driving functionalities is activated by the diagnostic command. This fault indicator shows that the motor vehicle is in an operating status in which it can be operated with at least limited driving functionalities, without a prior start-up of the automated clutch assembly.

It is preferably provided that the fault indication is retracted and/or the process for operating the motor vehicle with at least limited driving functionalities is ended when the start-up of the automated clutch assembly of this motor vehicle has been implemented and completed.

In the preferred embodiment it is provided that the gradual raising of the clutch element is effected, in that the clutch assembly is actuated based upon predetermined position defaults, preset by the electronic control unit, and especially is increasingly closed.

In this it is especially provided that the increase of the clutch torque is effected inside the control unit by means of corresponding master cylinder position defaults. In this preferred embodiment it is especially provided that the master cylinder is acted upon by a drive, such as an electric motor and/or some similar device, and itself acts upon a slave cylinder, which causes the opening status of the clutch to be changed.

In the preferred embodiment, within the framework of the production or assembly of the motor vehicle, the capability of operating with at least limited driving functionalities is activated by the installation of the actuator, or within the framework of the actuator assembly.

It is further preferred that the capability of operating with at least limited driving functionalities is effected by means of a command that is sent out by an electronic testing device. Most preferably, this can take place within the framework of regular service in an auto shop.

The object is further attained with an electronic control unit pursuant to claim 41.

The object is further attained with an electronic testing device pursuant to claim 42.

Within the meaning of the present invention, the term “control” is especially to be understood as “regulate” and/or “control” in the sense of the DIN. The same applies to terms derived from the term “control”.

The patent claims submitted with the application are proposed formulations, without prejudice to obtaining further patent protection. The applicant reserves the right to claim additional combinations of characterizing features that up to now have been disclosed only in the description and/or the drawings.

References used in the sub-claims refer to the further development of the object of the main claim through the characterizing features of that sub-claim; they are not to be understood as a waiver to obtaining independent, objective protection for the combination of characterizing features contained in the referenced sub-claims.

Because the objects of the sub-claims can represent objective and independent inventions on the priority date with respect to the prior art, the applicant reserves the right to make them the object of independent claims or declarations of division. They may also contain independent inventions, the form of which is independent from the objects of the preceding sub-claims.

The exemplary embodiments are not to be understood as a limitation of the invention. Rather, within the scope of the present disclosure, numerous changes and modifications are possible, especially such variants, elements, and combinations and/or materials that could be inferred by an expert in the field with respect to attaining the object, for example, by combining or modifying individual characterizing features or elements or process steps described in connection with the general description and embodiments, and the claims, and contained in the drawings, and that lead to a new object or to new process steps or process sequences as a result of combinable characterizing features, even to the extent that they involve production, testing, and working processes.

Below, preferred aspects of the invention will be specified in greater detail with reference to the drawings, without serving thereby to limit the invention.

The drawings show

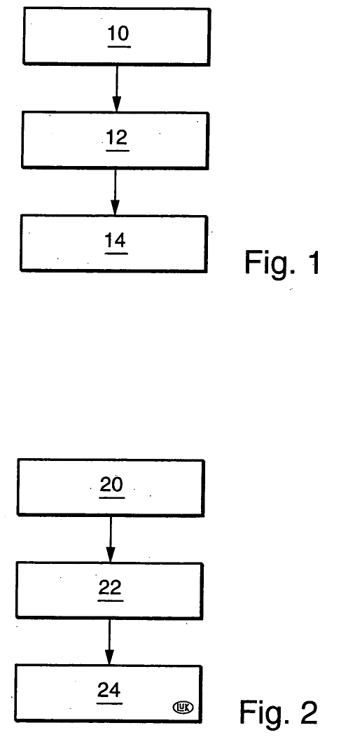

FIG. 1 a schematic representation of the stages of an exemplary process as specified in the Invention;

FIG. 2 a schematic representation of the stages of an exemplary process as specified in the Invention;

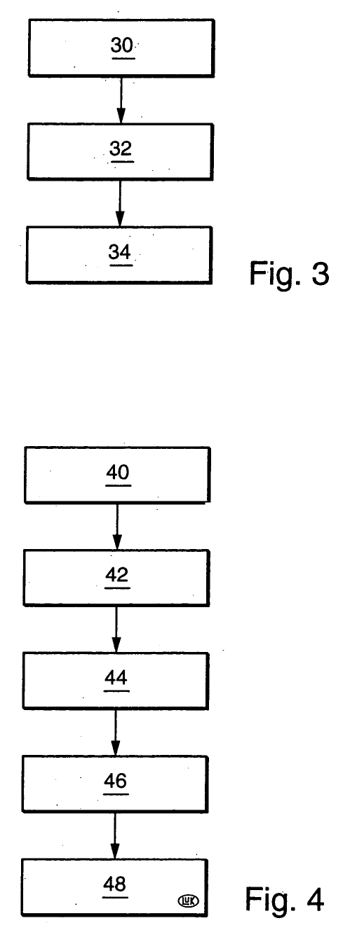

FIG. 3 a schematic representation of the stages of an exemplary process as specified in the Invention;

FIG. 4 a schematic representation of the stages of an exemplary process as specified in the Invention;

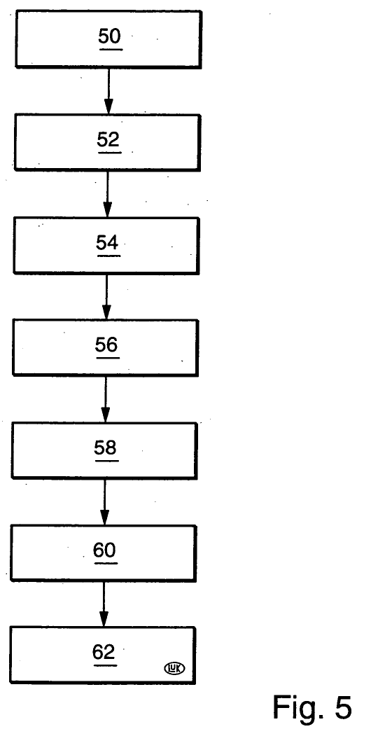

FIG. 5 a schematic representation of the stages of an exemplary process as specified in the Invention;

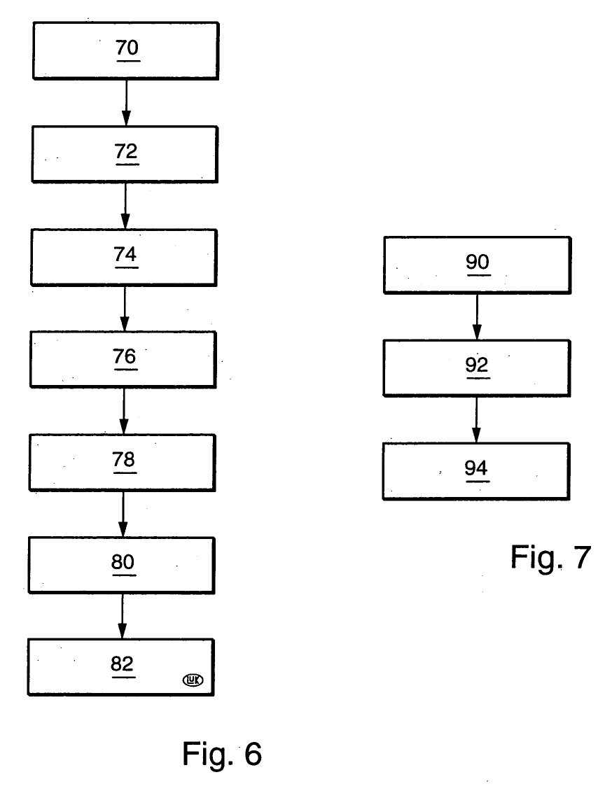

FIG. 6 a schematic representation of the stages of an exemplary process as specified in the Invention; and

FIG. 7 a schematic representation of the stages of an exemplary process as specified in the invention.

FIG. 1 shows a schematic representation of the stages of an exemplary process as specified in the invention.

In the stage 10 a diagnostic request is sent from an electronic testing device to an electronic control unit.

In the stage 12 the electronic control unit automatically checks the operational voltage of this electronic control unit and compares it with a preset limit for the electrical voltage supply. If it were determined in stage 12 that the instantaneous voltage present at the electronic control unit was below this limit, a fault indication would be acknowledged in stage 14, based upon the diagnostic request.

FIG. 2 shows a schematic representation of the stages of an exemplary process as specified in the invention.

In the stage 20 a testing device sends a command to an electronic control unit for a read-out of the operational voltage of this control unit, before transmitting a user-defined diagnostic request.

In the stage 22 the electronic control unit checks the operational electrical voltage present at this device, and communicates this to the electronic testing device.

In the stage 24 the electronic testing device sends a user-defined diagnostic request to the electronic control unit if the instantaneous operational voltage communicated by the testing device is not below a voltage level defined in the testing device.

FIG. 3 shows a schematic representation of the stages of an exemplary process as specified in the invention.

In the stage 30 a testing device checks the voltage at an ISO-K plug connector, which corresponds essentially to the operational voltage of the control unit.

In the stage 32, based upon this voltage that is present at the ISO-K plug connector, it is determined in the testing device whether or not a diagnostic request should be implemented. This determination is made especially by comparing the ascertained voltage level with the preset limit for electrical voltage.

If it is determined in the stage 32 that a diagnostic request is to be implemented or sent out, the electronic testing device sends the corresponding diagnostic request to the electronic control unit in the stage 34.

FIG. 4 shows a schematic representation of the stages of an exemplary process as specified in the invention.

In the stage 40, diagnostic software is transferred from an electronic testing device to an electronic control unit. This software is equipped with a multitude of fault recognition algorithms.

In the stage 42, the preset fault recognition algorithms run in the control unit, or are executed by means of the control unit, wherein the proper algorithms are triggered and monitored by the testing device. This serves to ensure that the diagnostic software will not permit normal driving operation of the motor vehicle, or will permit it only with a clear warning.

Further, here the control unit is in a status that requires a start-up of predetermined motor vehicle components prior to a normal driving operation of the motor vehicle.

In the stage 44 diagnostic results are transmitted from the control unit to the testing device.

In the stage 46 the diagnostic operation is completed.

In the stage 48 a start-up routine or several start-up routines for predetermined components of the motor vehicle are started and executed.

FIG. 5 shows a schematic representation of the stages of an exemplary process as specified in the invention.

In the stage 50 the process is initiated by a testing device or a hand-held tester.

In the stage 52 a movably arranged component of a transmission actuator is moved to an end position or extreme position or stop position.

In stage 54 the position of this component in the extreme position is ascertained by means of a pathway or position sensing device, and the ascertained value is recorded and/or stored.

In the stage 56 the movably arranged component is moved back and forth repeatedly between its extreme positions or stops.

In the stage 58 the movably arranged component is moved to the end position where the position was ascertained by the position sensing device and the corresponding value was recorded or stored.

In the stage 60 the value indicated by the position sensing device in this end position is read and compared with the stored value for the same end position.

If this comparison shows different values being indicated by the position sensing device for the same end position, it is determined in the stage 62 that the position sensing device is functionally impaired.

FIG. 6 shows a schematic representation of the stages of an exemplary process as specified in the invention.

In the stage 70 a transfer protocol is sent from a testing device in the direction of an interface that is arranged between this testing device and an electronic control unit.

In the stage 72 this transfer protocol or the corresponding data on the protocol side of this interface, which is equipped with a status byte for controlling the timing and with a data array, is converted to an internal protocol, wherein these data that are received from the testing device are accessed in writing.

In the stage 74, using these translated data on the application side of the interface, which is equipped with a status byte for controlling the timing and with a data array, the corresponding received diagnostic commands are converted into diagnostic functionalities, which are implemented by means of the control unit on the components to undergo diagnostics.

In the stage 78, the data array on the application side is accessed in writing, wherein the diagnostic results are implemented here.

In the stage 80 the data are translated on the protocol side.

In the stage 82 the translated data are sent to the testing device.

FIG. 7 shows a schematic representation of the stages of an exemplary process as specified in the invention.

In the stage 90 a motor vehicle is made available within the framework of the production process, in which the ECM system or the automated clutch assembly has not yet been placed in operation, in other words predetermined characteristic values for the clutch or characteristic values that are of importance in connection with the clutch have not yet been checked or ascertained. With this vehicle, a predetermined actuator, such as a clutch actuator or transmission actuator, has been adjusted beforehand so as to prevent recognition of the gears of the transmission assembly.

In the stage 92 a diagnostic command is sent out, which is sent out for example by an electronic testing device, and which produces reduced driving functionality in the motor vehicle.

In the stage 92 it is indicated that the driver wishes to start the vehicle. This can be indicated or defined for example, without serving hereby to limit the invention, in that a corresponding intention of the driver is recognized when the accelerator is pressed down or is pressed down a minimum amount while the engine is running.

In the stage 94, initiated by this intention of the driver, the clutch torque is gradually raised, wherein inside an electronic control unit a master cylinder position default for the master cylinder of an automated clutch assembly is executed.

1-42. (Canceled)

43. A method for performing a diagnostic operation in a motor vehicle equipped with an electronic control unit, which transmits and receives signals during the diagnostic operation and is connected to an electrical power source for a voltage supply, the method comprising the steps of:
determining an instantaneous operational voltage of the control unit; and
comparing the instantaneous operational voltage with a preset voltage limit.

44. A method for performing a diagnostic operation in a motor vehicle equipped with an electronic control unit, which transmits and receives signals during the diagnostic operation and is equipped with a memory unit, the method comprising the steps of:
loading diagnostic software into the memory unit of the control unit, the diagnostic software being capable of controlling at least one predetermined diagnostic routine or effecting implementation of the at least one diagnostic routine; and
automatically deleting the diagnostic software from the memory unit once a diagnostic operation has been executed or following implementation of the at least one diagnostic routine.

45. A method for performing a diagnostic operation in a motor vehicle equipped with an electronic control unit, which transmits and receives signals during the diagnostic operation, the method comprising the step of:
checking an ability to function of at least one position sensing device.

46. A method for performing a diagnostic operation in a motor vehicle equipped with an electronic control unit, which is placed in signal connection with an electronic testing device during the diagnostic operation, the method comprising the steps of:
transferring data between the testing device and the control unit via an interface during a diagnostic operation; the interface being equipped with a protocol side and a modular application side that differs from the protocol side;
translating diagnostic commands transmitted from the testing device, the protocol side being a protocol handler that translates the diagnostic commands; and
converting the translated diagnostic commands into diagnostic functionalities using the application side.

47. A method for operating a motor vehicle under at least limited driving functionalities prior to the start-up of an automated clutch assembly in the motor vehicle, the method comprising the steps of:
gradually raising a torque transferred and/or transferable by the clutch assembly when the motor vehicle is to be placed in operation on its own input in accordance with the intentions of the driver, and
activating the step of gradually raising the torque by a diagnostic command.

48. The method according to claim 43, further comprising the steps of:
ascertaining an instantaneous voltage supply during a diagnostic operation; and
comparing the instantaneous voltage supply with the preset voltage limit during a diagnostic operation.

49. The method according to claim 44, further comprising the steps of:
implementing various diagnostic routines during the diagnostic operation; and
determining a voltage limit based upon the at least one predetermined diagnostic routine.

50. The method according to claim 48, further comprising the step of:
indicating a fault when the instantaneous operational voltage is below the preset voltage limit.

51. The method according to claim 50, further comprising the step of:
determining the fault that is indicated when the instantaneous operational voltage is below the preset voltage limit based upon a specific diagnostic request.

52. The method according to claim 48, wherein at least one of the steps of ascertaining the instantaneous voltage supply, comparing the instantaneous voltage supply with the preset voltage limit, and indicating the fault are carried out automatically.

53. The method according to claim 48, wherein at least one of the steps of ascertaining the instantaneous voltage supply, comparing the instantaneous voltage supply with the preset voltage limit, and indicating the fault are controlled by the control unit.

54. The method according to claim 43, further comprising the step of:
placing the electronic control unit in signal connection with a testing device.

55. The method according to claim 54, further comprising the step of:
checking the voltage supply of the control unit using the testing device.

56. The method according to claim 46, further comprising the step of:
sending a signal to the control unit before transmitting a diagnostic request, thereby causing the instantaneous operational voltage to be communicated to the testing device, wherein the testing device sends the signal to the control unit.

57. The method according to claim 56, wherein the testing device sends a predetermined diagnostic request to the control unit only when the instantaneous operational voltage for the control unit that is communicated beforehand to the testing device is above the preset voltage limit.

58. The method according to claim 46, further comprising at least one of the following steps:
initiating an implementation of a proper diagnostic routine by the testing device; and
monitoring the implementation of the proper diagnostic routine by the testing device.

59. The method according to claim 46, further comprising the step of:
communicating predetermined diagnostic results to the testing device.

60. The method according to claim 44, further comprising at least one of the following steps:
preventing the motor vehicle from being operated in normal mode by the diagnostic software; and
producing a warning signal by the diagnostic software.

61. The method according to claim 44, further comprising the steps of:
indicating predetermined operational characteristic values for the motor vehicle; and
causing the implementation of at least one predetermined diagnostic routine to be prevented by the diagnostic software, based upon levels of the predetermined operational characteristic values.

62. The method according to claim 43, further comprising the step of:
executing at least one preset start-up routine upon completion of a diagnostic operation.

63. The method according to claim 45, further comprising the steps of:
ascertaining the position of at least one component in the motor vehicle by the position sensing device;
moving the at least one component in the motor vehicle during the diagnostic routine;
monitoring the change in positioned ascertained by the position sensing device; and
checking the change in position ascertained by the position sensing device for plausibility.

64. The method according to claim 45, wherein the position sensing device is an incremental sensor or is equipped with an incremental sensor.

65. The method according to claim 45, further comprising the step of:
initiating the diagnostic routine by a testing device for the purpose of performing a diagnostic operation on the position sensing device.

66. The method according to claim 65, further comprising at least one of the following steps:
controlling the diagnostic routine that is designed to perform a diagnostic operation on the position sensing device by an electronic control unit; and
implementing the diagnostic routine that is designed to perform the diagnostic operation on the position sensing device by the electronic control unit.

67. The method according to claim 68, further comprising the step of:
moving the movably arranged component back and forth at least one time between two extreme positions during the diagnostic routine that is designed to perform a diagnostic operation on the position sensing device.

68. The method according to claim 63, further comprising the steps of:
ascertaining a first position of the movably arranged component indicated by the position sensing device during the diagnostic routine that is designed to perform a diagnostic operation on the position sensing device, the indicated first position being shown relative to an end position prior to a back and forth movement of the movably arranged component between the end positions, the back and forth movement being executed at least one time;
ascertaining a second position that is shown relative to the end position after the back and forth movement; and
comparing the first and the second positions.

69. The method according to claim 68, further comprising the steps of:
determining that the position sensing device shows different position values for the first and the second positions after the step of comparing the first and the second positions;
indicating that the position sensing device is functionally impaired when the position sensing device shows the different position values for the same end position of the movably arranged element before and after the back and forth movement that is executed at least one time.

70. The method according to claim 65, further comprising the step of:
implementing the diagnostic routine that is designed to perform a diagnostic operation on the position sensing device in order to identify directionally dependent functional impairments of the position sensing device.

71. The method according to claim 63, wherein the movably arranged component is at least one of a component of an actuator and a component that is acted upon by the actuator.

72. The method according to claim 63, further comprising the step of:
separately implementing the diagnostic routine that is designed to perform a diagnostic operation on the position sensing device for different actuators or for position sensing devices allocated to the actuators.

73. The method according to claim 46, further comprising the step of:
transmitting diagnostic results from the control unit to the testing device via the interface, wherein the diagnostic results ate supplied by the application side and translated by the protocol side.

74. The method according to claim 46, wherein the application side and the protocol side are each equipped with a data array.

75. The method according to claim 74, wherein the data array on the application side has received data that is received by the control unit and sent data that is sent by the control unit, and the data array on the protocol side has received data that is received by the control unit and sent data that is sent by the control unit.

76. The method according to claim 75, wherein the protocol side accesses only the received data of the data array on the protocol side in writing.

77. The method according to claim 75, wherein the application side accesses only the sent data of the data array on the application side in writing.

78. The method according to claim 75, further comprising the step of:
controlling the diagnostic operation by means of status bytes, wherein the application side and the protocol side are each equipped with one of the status bytes.

79. The method according to claim 47, further comprising the steps of:
activating an at least limited driving functionality, in which the motor vehicle can be operated with limited driving functionality, by a diagnostic command;
registering a fault in a fault indicator in an electronic control unit of the motor vehicle when the at least limited driving functionality is activated by the diagnostic command, wherein the fault indicator shows that the motor vehicle is in an operational status in which it can be operated under the at least limited driving functionality, without a start-up of the automated clutch assembly.

80. The method according to claim 79, further comprising at least one of the steps of:
canceling the fault indicator; and
ending the process for operating the motor vehicle with the at least limited driving functionality prior to the start-up of the automated clutch assembly once the start-up of the automated clutch assembly of the motor vehicle has taken place and is completed.

81. The method according to claim 47, further comprising the step of:
gradually raising the clutch torque with a correspondingly indicated intention from a driver, the clutch torque being transferable by the clutch assembly and the clutch assembly being closed in accordance with preset position defaults provided by the control unit, when the motor vehicle is driven with at least limited driving functionality prior to a start-up of an automated clutch assembly in the motor vehicle.
